(19) United States
(12) Patent Application Publication
(10) Pub. No.: US 2008/0248183 A1
(43) Pub. Date: Oct. 9, 2008

(54) SUGAR FREE AND REDUCED SUGAR CHOCOLATE AND METHODS OF MANUFACTURE

(76) Inventor: Robert Brown, San Jose (CR)

Correspondence Address: MEREDITH & KEYHANI, PLLC, 330 MADISON AVE., 6TH FLOOR, NEW YORK, NY, 10017, US

(21) Appl. No.: 11/696,946

(22) Filed: Apr. 5, 2007

(51) Int. Cl. A23C 9/00; A23D 7/00; A23L 1/212; A23L 1/36

(52) U.S. Cl. 426/588; 426/601; 426/615; 426/632; 426/638; 426/639; 426/629

(57) ABSTRACT

A method of producing a sugar free chocolate composition comprising the steps of: thoroughly mixing at least the following ingredients: 1 to 60% by weight agave syrup; and 25 to 99% by weight cacao liquor; so as to produce an aqueous solution; conching the aqueous solution; evaporating water from the aqueous solution utilizing an additional water removal means during the conching step to provide a conched chocolate; tempering the conched chocolate to provide a chocolate product; and forming the chocolate product.

The present invention relates generally to sugar free chocolate and methods of manufacturing sugar free chocolates utilizing natural and/or organic ingredients.

The health benefits of Cacao are well known. Cacao is rich in antioxidants, has been associated with decreased diabetes and blood pressure, is rich in B1, B2 and D vitamins, magnesium and iron, is associated with improved vasodilatation, helping increase stamina during exercise, is cholesterol free and may even block oxidation of LDL cholesterol. Chocolate is associated with euphoria and reduced depression due to phenylthylamine. Serotonin, a well-studied neurotransmitter, is thought to instill calm and relaxed feelings. Chocolate is associated with increased serotonin levels, a factor that is believed to explain chocolate cravings.

While Cacao has many health benefits, sugar is generally added to make the taste palatable and has many health drawbacks. Sugar may cause hypertension, added calories, diabetes, tooth decay and weight gain. There are over one (100) well known and documented detrimental health effects associated with sugar. High-sugar foods also displace whole foods and contribute to nutritional deficiencies adding empty calories that few Americans need. High sugar foods contribute to obesity now considered by some in the medical profession as a disease.

One sugar substitute is Agave. Agave has health-promoting components that have many positive effects including having a direct stimulatory effect on the immune system, increase the effectiveness of both injected and oral vaccines, decrease blood lipids, lower cancer risks, and lower blood glucose response, inhibits dental aries and platelet aggregation. However, the problem with the addition of Agave is that it is made up of approximately twenty five percent (25%) water. Chocolate production and processing methods avoid contact with water since small amounts of added water causes severe rheological changes in the product, usually accompanied by lumping and/or granulation leading to a coarse unacceptable eating texture (Minifie, B.W. Chocolate, Cocoa and Confectionary-Science and Technology, 3 edition, Chapman & Hall (1989)). Larger amounts of water results in a fudge like product that has a short shelf life and lacks the “snap, luster and taste” of chocolate products.

Because of the difficulty of adding sugar substitutes that contain water, Chocolatiers have generally utilized chemically based sugar substitutes, such as xylitol, sorbitol, mannitol, lactitol, malitol, isomalt, polydextrose and other chemically created sugar substitutes. However, such substitutes could never be natural, organic and/or sugar free and such products are increasingly popular.

Accordingly, the present invention has solved the long felt need of the chocolate industry by utilizing Agave as a sweetener to provide a natural and/or organic, sugar free chocolate that tastes goods, remains stable at room temperature and has the desired snap, luster and taste that consumers demand.

### SUMMARY OF THE INVENTION

The present invention relates generally to sugar free chocolates utilizing natural and/or organic ingredients and their method of manufacture.

According to one embodiment, a method of producing a sugar free chocolate composition is disclosed comprising the steps of: thoroughly mixing at least the following ingredients: 1 to 60% agave syrup; and 25 to 99% cacao liquor; so as to produce an aqueous solution; conching the aqueous solution; evaporating water from the aqueous solution utilizing an additional water removal means during the conching step to provide a conched chocolate; tempering the conched chocolate to provide a chocolate product; and forming a chocolate product. The chocolate may also include 1 to 40% by weight of at least one edible fat included in the first mixing step. The resulting chocolate may be organic and/or natural depending on the ingredients used.

According to another embodiment, a method of producing a sugar free chocolate composition comprising the steps of: thoroughly mixing at least the following ingredients to provide a mixture: 1 to 60% agave syrup; and 25 to 99% cacao liquor; evaporating water from the mixture utilizing an additional water removal means to provide a lower water content mixture; conching the lower water content mixture; evaporating water from the lower water content mixture utilizing an additional water removal means during the conching step to provide a conched chocolate; tempering the conched chocolate to provide a chocolate product; and forming the chocolate product. The chocolate may also include 1 to 40% by weight of at least one edible fat. The edible fat may be selected from (a) cocoa butter and (b) cocoa butter and at least one other edible fat and is included in the first mixing step.

A method of producing a sugar free chocolate composition comprising the steps of: evaporating water from agave syrup to provide agave powder; thoroughly mixing at least the following ingredients to provide a mixture: 1 to 40% by weight of at least one edible fat, wherein the edible fat may be selected from (a) cocoa butter and (b) cocoa butter and at least one other fat; 1 to 60% agave powder; and 25 to 70% cacao liquor; so as to produce a mixture; conching the mixture; evaporating water from the mixture utilizing an additional water removal means during the conching step to provide a conched chocolate; tempering the conched chocolate to provide a chocolate product; and forming the chocolate product.

These and other features, aspects and advantages of the present invention will become better understood with reference to the following description and claims.

### BRIEF DESCRIPTION OF THE DRAWINGS

FIG. 1 depicts the present invention;

FIG. 2 depicts the present invention;

FIG. 3 depicts the present invention; and

FIG. 4 depicts the present invention.

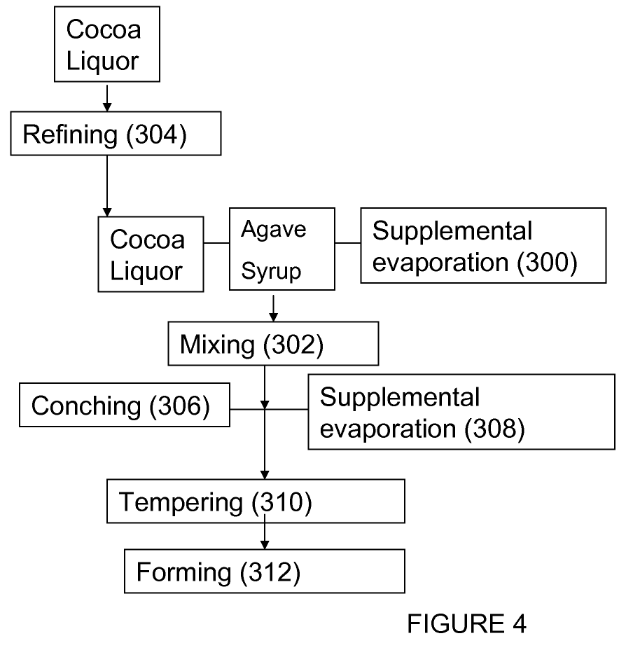

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

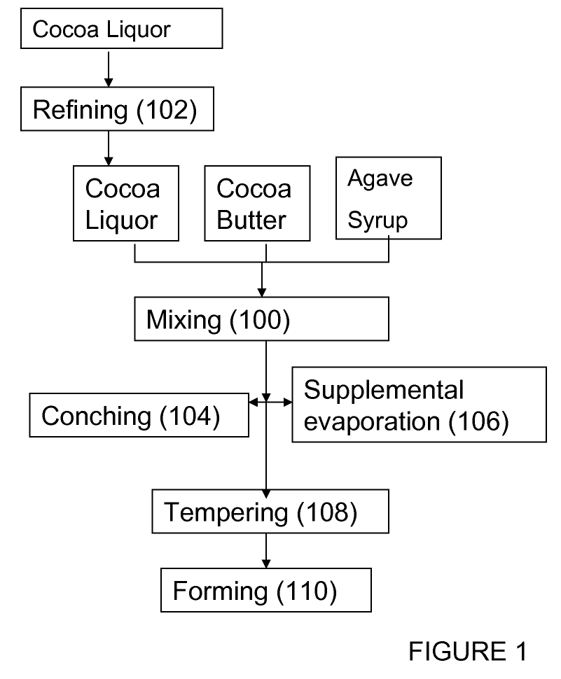

As depicted in FIGS. 1-3, the present invention provides sugar free natural chocolate and methods of manufacturing sugar free natural and/or organic chocolate. Agave syrup (also called agave nectar) is a sweetener mostly produced in Mexico, from several species of agave, including Agave tequilana (also called Blue Agave or Tequila Agave), and the Salmiana, Green, Grey, Thorny, and Rainbow varieties. Agave syrup is sweeter than honey, though less viscous. The main carbohydrate is a complex form of fructose. Agave syrup consists primarily of fructose and glucose. One source gives 92% fructose and 8% glucose. One of the benefits of the Agave syrup is that it has a very low Glycemic Index of 19 to 27. The complex composition of the molecules of Agave cause the fructose and glucose to pass through the body without the sucrose or fructose digested into the blood stream as with sugars. Thus weight gain, highs and lows of sugar ingestion, and all the detrimental affects of sugar are avoided.

As shown in FIG. 1, a method of producing a sugar free chocolate composition is provided comprising the steps of: thoroughly mixing (100) at least the following ingredients: 1 to 40% by weight of at least one edible fat. The edible fat may be selected from (a) cocoa butter and (b) cocoa butter and at least one other fat; 1 to 60% agave syrup; and 25 to 99%, more preferably between 25 and 70%, % cacao liquor; so as to produce an aqueous solution; conching (104) the aqueous solution; evaporating (106) water from the aqueous solution utilizing an additional water removal means during the conching step to provide a conched chocolate; tempering (108) the conched chocolate to product a chocolate product; and forming (110) the chocolate product. The at least one edible fat may be emulsified with the aqueous solution. The Cacao butter is preferably between 20% and 40%, if Cacao butter is used as the edible fat. Any other edible fats, or mixture of edible fats, may be used without departing from the present invention. According to a preferred embodiment, the cacao butter is about 20% by weight, the Cacao Liquor is about 55% by weight and the Agave Syrup is about 25% by weight. The additional water removal means is selected from the group consisting of a vacuum and a dehydration attachment. A conching machine will, over time, result in decreased water content, due to the heat created by the movement of the mixture. However, the small amount of dehydration is not sufficient to provide a chocolate of the desired texture, shelf life, snap, luster and taste. The present invention requires additional evaporation to prevent the chocolate from turning fudge like, chunky and having an unpleasant texture. The step of tempering (108) allows the chocolate to be molded to form a bar, drop or any shape of a mold. The chocolate can be tempered for spraying in panning and other methods for covering diverse items. There may also be the step of adding a flavor enhancer. The flavor enhancer may be selected from the group consisting of milk powder, caramel, nougat, herbs, spices, fruit, nuts, sugar, sugar substitute and any combination thereof. The milk powder may be added prior initially, prior to mixing (100) or even during the step of forming (110) the chocolate product, as would be the case with coatings. Additional sugars and sugar substitutes may be added at any step in the invention, without departing from the present invention. It may, for example, be desirable to use agave syrup and sugar or agave syrup and a sugar substitute. In this way, the sugar levels may be adjusted according to the needs of the consumers. The steps, as disclosed, provide a chocolate that has a distinctive snap, luster, and taste after forming stays solid and hard at room temperature, does not bloom and has a shelf life of at least one year.

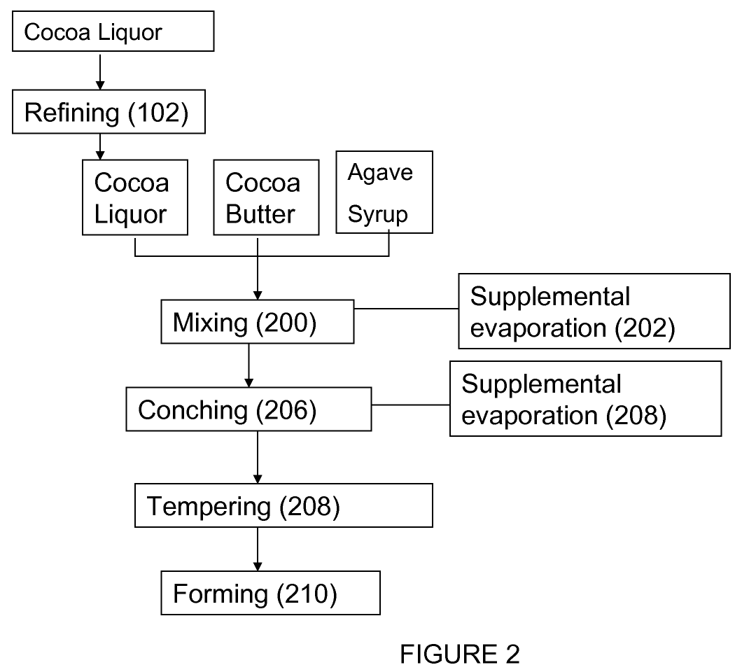

As shown in FIG. 2, a method of producing a sugar free chocolate composition is disclosed comprising the steps of: thoroughly mixing (200) at least the following ingredients to provide a mixture: 20 to 40% by weight of at least one edible fat selected from (a) cocoa butter and (b) cocoa butter and at least one other fat; 1 to 60% by weight agave syrup; and 25 to 99% by weight (more preferably between 25 and 75%) % cacao liquor; evaporating (202) water from the mixture utilizing an additional water removal means to provide a lower water content mixture; refining (204) the lower water content mixture; conching (206) the lower water content mixture; evaporating (208) water from the lower water content mixture utilizing an additional water removal means during the conching step to provide a conched chocolate; tempering (208) the conched chocolate to provide a chocolate product; and forming (210) the chocolate product. The additional water removal means may be selected from the group consisting of a vacuum and a dehydration attachment. According to the embodiment, as shown in FIG. 2, there may be two dehydration/evaporation steps.

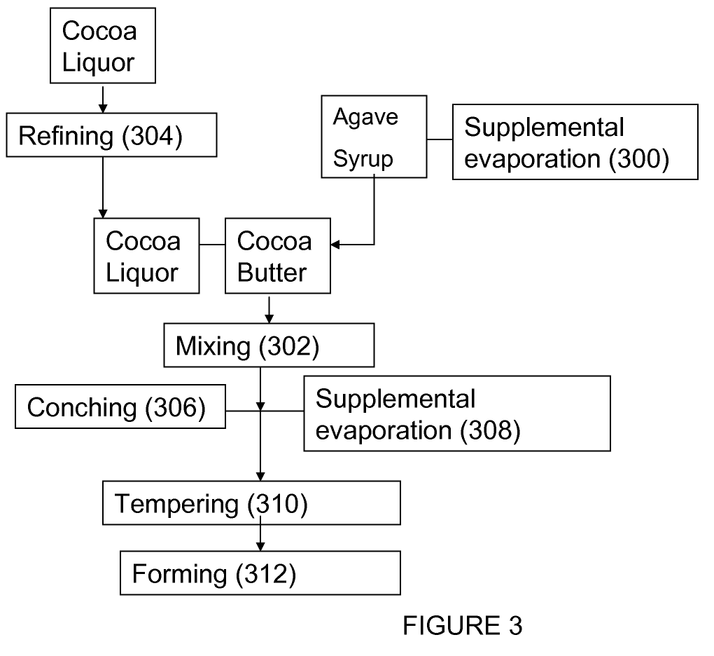

As shown in FIG. 3, a method of producing a sugar free chocolate composition is provided comprising the steps of: (300) evaporating water from agave syrup to provide agave powder; thoroughly mixing (302) at least the following ingredients to provide a mixture: 20 to 40% by weight of at least one edible fat selected from (a) cocoa butter and (b) cocoa butter and at least one other fat; 1 to 60% by weight agave powder; and 25 to 70% by weight cacao liquor; so as to produce a mixture; refining (304) the mixture; conching (306) the mixture; evaporating (308) water from the mixture utilizing an additional water removal means during the conching step to provide a conched chocolate; tempering (310) the conched chocolate to product a chocolate product; and forming (312) the chocolate product.

It should be understood that the foregoing relates to preferred embodiments of the invention and that modifications may be made without departing from the spirit and scope of the invention as set forth in the following claims.

I claim:

1. A method of producing a sugar free chocolate composition comprising the steps of:
thoroughly mixing at least the following ingredients:
1 to 60% by weight agave syrup; and
25 to 99% by weight cacao liquor;
so as to produce an aqueous solution;
conching said aqueous solution;
evaporating water from said aqueous solution utilizing an additional water removal means during said conching step to provide a conched chocolate;
tempering said conched chocolate to provide a chocolate product; and
forming said chocolate product.

2. A method as in claim 1, wherein said step of thoroughly mixing, further comprising the step of:
Thoroughly mixing 1 to 40% by weight of at least one edible fat with at least said agave syrup and said cacao liquor.

3. A method as in claim 2, wherein said at least one edible fat is selected from (a) cocoa butter and (b) cocoa butter and at least one other edible fat.

4. A method as in claim 2, wherein said at least one edible fat is emulsified with the said aqueous solution.

5. A method as in claim 2, wherein said cacao butter is about 20% by weight, said Cacao Liquor is about 55% by weight and said Agave Syrup is about 25% by weight.

6. A method as in claim 1, wherein said additional water removal means is selected from the group consisting of a vacuum and a dehydration attachment.

7. A method as in claim 1, further comprising the step of adding a flavor enhancer, wherein said flavor enhancer is selected from the group consisting of milk powder, sugar, sugar substitute, caramel, nougat, herbs, spices, fruit, nuts and any combination thereof.

8. A method as in claim 1, further comprising the step of:
refining said cacao liquor prior to said mixing step.

9. A method of producing a sugar free chocolate composition comprising the steps of:
thoroughly mixing at least the following ingredients to provide a mixture:
1 to 60% by weight agave syrup; and
25 to 70% by weight cacao liquor;
evaporating water from said mixture utilizing an additional water removal means to provide a lower water content mixture;
conching said lower water content mixture;
evaporating water from said lower water content mixture utilizing an additional water removal means during said conching step to provide a conched chocolate;
tempering said conched chocolate to provide a chocolate product; and
forming said chocolate product.

10. A method as in claim 9, wherein said step of thoroughly mixing, further comprising the step of:
thoroughly mixing 1 to 40% by weight of at least one edible fat with at least said agave syrup and said cacao liquor.

11. A method as in claim 10, wherein said at least one edible fat is selected from (a) cocoa butter and (b) cocoa butter and at least one other edible fat.

12. A method as in claim 10, wherein said at least one edible fat is emulsified.

13. A method as in claim 10, wherein said cacao butter is about 20% by weight, said Cacao Liquor is about 55% by weight and said Agave Syrup is about 25% by weight.

14. A method as in claim 10, wherein said additional water removal means is selected from the group consisting of a vacuum and a dehydration attachment.

15. A method as in claim 10, further comprising the step of adding a flavor enhancer, wherein said flavor enhancer is selected from the group consisting of milk powder, caramel, nougat, herbs, spices, sugar, sugar substitute, fruit, nuts and any combination thereof.

16. A method as in claim 8, further comprising the step of:
refining said cacao liquor prior to said mixing step.

17. A method of producing a sugar free chocolate composition comprising the steps of:
evaporating water from agave syrup to provide agave powder;
thoroughly mixing at least the following ingredients to provide a mixture:
1 to 40% by weight of at least one edible fat selected from (a) cocoa butter and (b) cocoa butter and at least one other edible fat;
1 to 60% by weight agave powder; and
25 to 70% by weight cacao liquor;
so as to produce a mixture;
conching said mixture;
evaporating water from said mixture utilizing an additional water removal means during said conching step to provide a conched chocolate;
tempering said conched chocolate to provide a chocolate product; and
forming said chocolate product.

17. A method as in claim 16, wherein said cacao butter is about 20% by weight, said Cacao Liquor is about 55% by weight and said Agave powder is about 25% by weight.

18. A method as in claim 16, wherein said additional water removal means is selected from the group consisting of a vacuum and a dehydration attachment.

19. A method as in claim 16, further comprising the step of adding a flavor enhancer, wherein said flavor enhancer is selected from the group consisting of milk powder, caramel, sugar, sugar substitute, nougat, herbs, spices, fruit, nuts and any combination thereof.

20. A method as in claim 16, further comprising the step of:
refining said cacao liquor prior to said mixing step.
